(19) United States
(12) Patent Application Publication
(10) Pub. No.: US 2004/0216386 A1
(43) Pub. Date: Nov. 4, 2004

(54) Vehicle door having unitary inner panel and outer panel

(76) Inventors: Adrian B. Chernoff, Royal Oak, MI (US); Tommy E. White, Rochester Hills, MI (US)

Correspondence Address: KATHRYN A. MARRA, General Motors Corporation, Legal Staff, Mail Code 482-C23-B21, P.O. Box 300, Detroit, MI, 48265-3000, US

(21) Appl. No.: 10/426,905

(22) Filed: Apr. 29, 2003

(51) Int. Cl. B60J 5/04

(52) U.S. Cl. 49/502

(57) ABSTRACT

A vehicle door includes a unitary, one-piece panel. The panel has both an inner panel portion and an outer panel portion, and is bent or folded such that the inner panel portion and the outer panel portion at least partially define a cavity therebetween. Door hardware can be operatively connected to the panel before the panel is bent or folded, thus providing a door assembler with unhindered access to the hardware mounting surfaces. A method of manufacturing a vehicle door employing the panel is also provided.

### TECHNICAL FIELD

This invention relates to vehicle doors characterized by a unitary, one-piece panel that forms an inner panel and an outer panel.

### BACKGROUND OF THE INVENTION

A prior art vehicle door typically includes an inner panel and an outer panel that are formed from separate metal blanks. The inner panel and the outer panel are joined together substantially along their respective peripheries by welding, hemming, etc. The prior art inner panel and outer panel may move relative to one another during the joining process, resulting in dimensional variations across a plurality of doors.

The inner panel and the outer panel form a cavity therebetween. After the inner panel and the outer panel are joined, door hardware, such as a window, a window regulator, a latch, etc., is loaded into the cavity through openings formed in the inner panel. Hardware installation may be cumbersome because of the limited size of the openings. The prior art door must be of sufficient thickness that an assembler can manipulate and arrange hardware within the cavity during installation. However, it is desirable to minimize door thickness to increase vehicle passenger space and to provide designers with more door styling options.

### SUMMARY OF THE INVENTION

A vehicle door is provided that comprises a unitary, one-piece panel having both an inner panel portion and an outer panel portion. The panel is folded or bent so that the inner panel portion and the outer panel portion at least partially define a cavity therebetween in which door hardware can be located. The vehicle door has fewer tolerance stack-ups and enables better dimensional control in manufacturing compared to the prior art because the inner panel portion and the outer panel portion are part of a single piece of material.

Furthermore, door hardware can be advantageously mounted to the inner panel portion before the panel is bent or folded. Thus, an assembler is not impeded by the prior art limitations of having to load the hardware through openings in the inner panel and having to manipulate and arrange the door hardware within an essentially closed cavity. The cavity between the inner panel portion and the outer panel portion can be made smaller than the cavities of prior art doors because the assembler need not manipulate and arrange door hardware within the cavity during hardware installation.

The vehicle door can be thinner than a prior art door because it has fewer tolerance stack-ups, enables better dimensional control in manufacturing, and requires less cavity space for door hardware installation compared to a prior art door. Thus, the vehicle door facilitates a more spacious vehicle interior and more vehicle exterior design options.

A method of manufacturing a door having a one-piece panel formed to include an inner panel portion and an outer panel portion is also provided.

The above features and advantages, and other features and advantages, of the present invention are readily apparent from the following detailed description of the best modes for carrying out the invention when taken in connection with the accompanying drawings.

### BRIEF DESCRIPTION OF THE DRAWINGS

FIG. 1 is a perspective schematic view of a unitary, one-piece panel having an inner panel portion and an outer panel portion in a progressive first configuration;

FIG. 2 is a perspective schematic view of the panel of FIG. 1 in a progressive intermediate configuration in which the panel is partially bent along a fold line;

FIG. 3 is a perspective schematic view of a vehicle door including the panel of FIGS. 1 and 2 in a progressive final configuration; and

FIG. 4 is a schematic cross sectional view of a vehicle door having an alternative unitary one-piece panel design.

### DESCRIPTION OF THE PREFERRED EMBODIMENTS

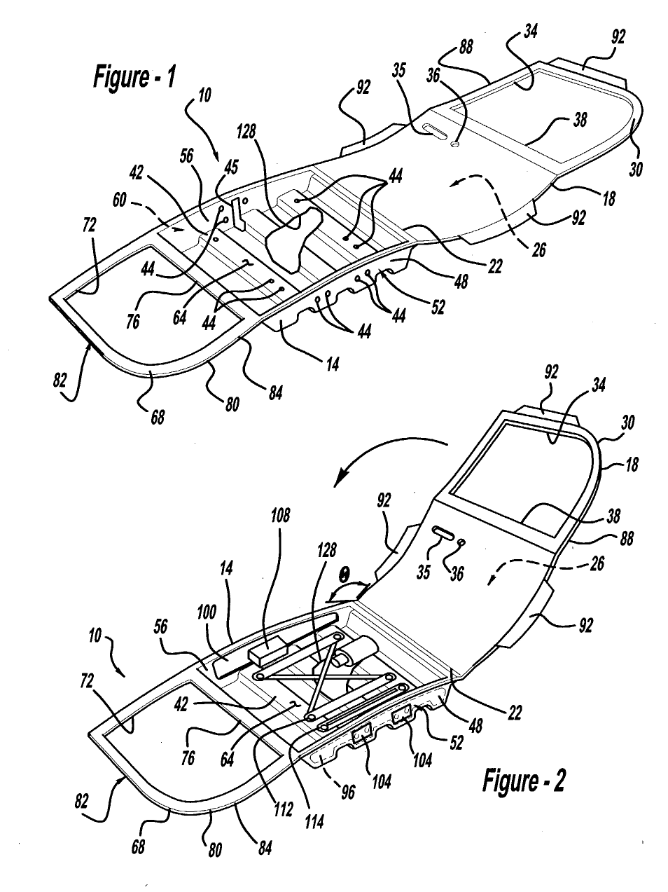

FIG. 1 is a schematic depiction of a unitary, one-piece panel 10 in a progressive first configuration. The panel 10 is characterized by an inner panel portion 14 and an outer panel portion 18. The inner panel portion 14 and the outer panel portion 18 are separated by a fold line 22 at which the panel 10 is bendable or foldable to at least partially form a vehicle door.

The outer panel portion 18 has a contoured surface 26 that partially defines the exterior surface of a vehicle. The outer panel portion 18 also includes an outer panel window frame 30 that partially defines an outer panel window opening 34. An edge 38 forms an outer panel window sill and further defines the window opening 34. An outer door handle opening 35 and a key cylinder opening 36 are defined by the outer panel portion 18.

The inner panel portion 14 preferably includes formations such as stiffening corrugations 42 to provide a vehicle door of which the panel 10 is a part with structural rigidity. The inner panel portion 14 also defines apertures 44 for mounting and supporting door hardware. An opening 45 is provided for a latch to engage a complementary striker on a vehicle body (not shown). The inner panel portion 14 includes a side wall 48 forming a hinge face 52 and an opposing side wall 56 forming a lock face 60. The side walls 48, 56 partially define a concavity 64. The inner panel portion 14 includes an inner panel window frame 68 that partially defines an inner panel window opening 72. An edge 76 forms an inner panel window sill that defines the lower extent of the inner panel window opening 72.

The panel 10 is characterized by a periphery 80 and a peripheral edge 82. The inner panel periphery 84 is the segment of the periphery 80 on the inner panel portion side of the fold line 22. The outer panel periphery 88 is the segment of the periphery 80 on the outer panel portion side of the fold line 22. The outer panel portion preferably includes hem flanges 92 at the outer panel periphery 88 to facilitate the joining of the inner panel portion 14 to the outer panel portion 18 along their respective peripheries 84, 88.

Those skilled in the art will recognize a variety of materials that may be employed to form the panel 10, including various metals and plastics. Those skilled in the art will also recognize a variety of forming techniques that may be employed within the scope of the claimed invention to form the contours of panel 10, such as, but not limited to, stamping, injection molding, etc. However, quick plastic forming, superplastic forming, or sheet hydroforming is preferably employed to form the contours of the panel 10 so that the panel 10 has a more complex shape than is generally achievable with stamping. Holes, apertures, and openings are cut, punched, etc, after the contours are formed.

Superplastic forming is described in U.S. Pat. No. 5,974,847, issued Nov. 2, 1999 to Saunders, et al, which is hereby incorporated by reference in its entirety. When certain alloy compositions of steel or aluminum are suitably processed (such as with a very fine grain microstructure), they exhibit superplastic behavior at certain elevated temperatures. When deformed at these temperatures, the ductility (or elongation before yield or failure) of these materials exceeds several hundred percent. Such high levels of ductility can enable fabrication of very complex structures in a single sheet of material. A panel 10 of the design discussed above can be fabricated in one piece using such techniques.

In addition to various steels and aluminum alloys, other structural materials such as zinc, brass, magnesium, titanium and their alloys have also been reported to exhibit superplastic behavior. Furthermore, certain polymers and reinforced polymer composites have the required ductility to make this panel 10. These materials and other metal matrix composites could also be used to make the panel 10 of this invention, if desired.

In an example of superplastic forming (SPF), a blank, i.e., a sheet, is tightly clamped at its edges between complementary surfaces of opposing die members. At least one of the die members has a cavity with a forming surface opposite one face of the sheet. The other die opposite the other face of the sheet forms a pressure chamber with the sheet as one wall to contain the working gas for the forming step. The dies and the sheet are heated to a suitable SPF condition for the alloy. For SPF aluminum alloys, this temperature is typically in the range of 400° C. to 550° C. Electric resistance heating elements are located in press platens or sometimes embedded in ceramic or metal pressure plates located between the die members and the platens. A suitable pressurized gas such as argon is gradually introduced into the die chamber on one side of the sheet, and the hot, relatively ductile sheet is stretched at a suitable rate until it is permanently reshaped against the forming surface of the opposite die. The rate of pressurization is controlled so the strain rates induced in the sheet being deformed are consistent with the required elongation for part forming. Suitable strain rates are usually 0.0001 to 0.01 s⁻¹. During the deformation of the sheet, gas is vented from the forming die chamber.

The '847 patent provides a method of stretch forming a ductile metal sheet into a complex shape involving significant deformation without excessive thinning of the sheet material and without tearing it. The method is particularly applicable to the stretch forming of superplastic alloys heated to a superplastic forming temperature. In the method, additional material from the initially flat sheet blank is pulled or drawn into the forming cavity for stretch forming. The additional material significantly reduces thinning and tearing in the formed part.

The method contributes to thickness uniformity in an SPF stretch-formed component by utilizing controlled draw-in of sheet metal to the forming chamber prior to application of gas pressure. In an illustrative practice, a preform, similar to a stationary male punch, is placed on the forming press platen opposite the die cavity. An aluminum blank, for example, is placed over the insert and heated to a suitable SPF temperature for the alloy. The die is then moved toward its closed position against the platen. In its closing motion, the die engages the edges of the aluminum sheet. The heated metal is pulled over and around the insert, and draw-in of blank material thus occurs. This results in a greater amount of metal in the die cavity prior to SPF blow forming. The quantity of additional metal can be managed by design of the size, shape and location of the preform on the platen or complementary die member. But the additional metal in the die cavity reduces the amount of strain required and, hence, the amount of thinning to form a desired geometry compared to conventional SPF.

Thus, by the judicious use of a suitable space-occupying metal preform on a die or platen member opposite the forming die, additional metal is easily drawn into the cavity during die closure without significantly increasing the complexity of the tooling. Care is taken in the design of the preform to avoid excessive wrinkling of the drawn-in metal and to maintain a tight gas seal at the periphery of the sheet upon full die closure. The uniformity in thickness of the stretch-formed part is improved. Mass of the formed part can be reduced because the designer does not need to resort to thicker blanks to assure part quality. And, except for the simple preform, there is no increase in the complexity of the SPF tooling.

Quick plastic forming is described in U.S. Pat. No. 6,253,588, issued Jul. 3, 2001 to Rashid, et al, which is hereby incorporated by reference in its entirety. For quick plastic forming, a preferred alloy is Aluminum Alloy 5083 having a typical composition, by weight, of about 4% to 5% magnesium, 0.3 to 1% manganese, a maximum of 0.25% chromium, about 0.1% copper, up to about 0.3% iron, up to about 0.2% silicon, and the balance substantially all aluminum. Generally, the alloy is first hot and then cold rolled to a thickness from about one to about four millimeters.

In the AA5083 alloys, the microstructure is characterized by a principal phase of a solid solution of magnesium in aluminum with well-distributed, finely dispersed particles of intermetallic compounds containing the minor alloying constituents, such as Al₆Mn.

Using QPF, large AA5083-type aluminum-magnesium alloy sheet stock may be formed into a complex three-dimensional shape with high elongation regions, like an SPF-formed part, at much higher production rates than those achieved by SPF practices. The magnesium-containing, aluminum sheet is heated to a forming temperature in the range of about 400° C. to 510° C. (750° F. to 950° F.). The forming may often be conducted at a temperature of 460° C. or lower. The heated sheet is stretched against a forming tool and into conformance with the forming surface of the tool by air or gas pressure against the back surface of the sheet. The fluid pressure is preferably increased continuously or stepwise from 0 psi gage at initial pressurization to a final pressure of about 250 to 500 psi (gage pressure, i.e., above ambient pressure) or higher. During the first several seconds up to about, e.g., one minute of increasing pressure application, the sheet accommodates itself on the tool surface. After this initial period of pressurization to initiate stretching of the sheet, the pressure can then be increased at an even faster rate. Depending upon the size and complexity of the panel to be formed, such forming can normally be completed in a period of about two to twelve minutes, considerably faster than realized in superplastic forming. Thus, by working a suitably fine grained, aluminum alloy sheet at significantly lower temperatures and continuously increased, higher gas pressures than typical SPF practices, significantly faster and more practical forming (at least for the automobile industry) times are achieved.

Referring to FIG. 2, wherein like reference numbers refer to like components from FIG. 1, the panel 10 is depicted in a progressive intermediate configuration in which the panel 10 is bent or folded along the fold line 22. In a preferred embodiment, reinforcements and door hardware are mounted to the panel 10 when the angle [symbol] between the inner panel portion 14 and the outer panel portion 18 is approximately 45 degrees so that a door assembler has substantially unimpeded access to the concavity 64. Reinforcements include a hinge reinforcement 96 operatively connected to side wall 48 and a latch reinforcement 100 operatively connected to side wall 56. Exemplary door hardware includes a pair of hinges 104 mounted to side wall 48, a latch 108 mounted to side wall 56, and a window regulator 112 and window guide 114 mounted to the inner panel portion 14. Reinforcements 96, 100 are preferably welded to the panel 10, and door hardware 104, 108, 112, 114 is preferably mounted at the apertures using mechanical fasteners (not shown). Alternatively, the panel 10 may be of sufficient thickness, and have sufficient stiffening formations, such that the installation of separate reinforcement members 96, 100 is not necessary. The panel 10 is preferably painted after the reinforcements 96, 100 are welded to the panel 10, and before the hardware 104, 108, 112, 114 is installed. Those skilled in the art will recognize and understand the proper placement of other door hardware components, such as door handles, lock rods, key cylinders, etc. and their corresponding apertures in the panel 10.

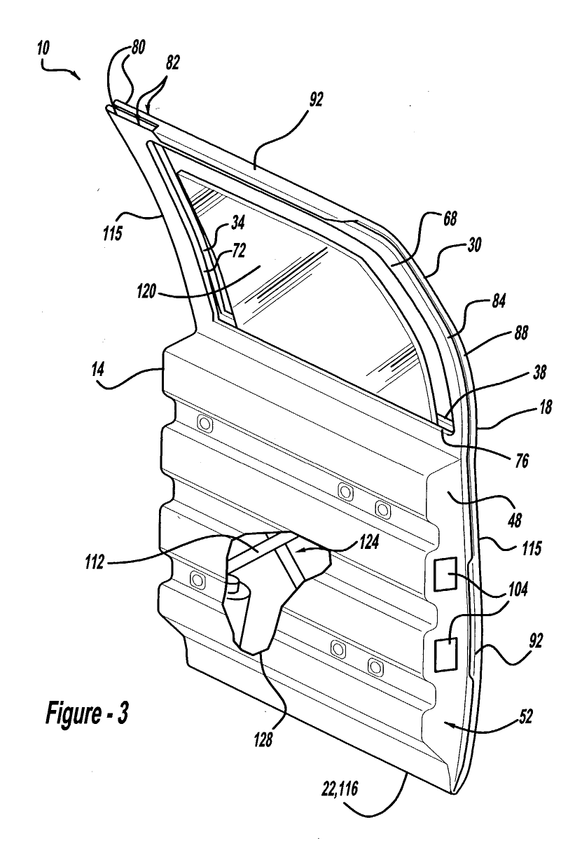

Referring to FIG. 3, wherein like reference numbers refer to like components from FIGS. 1 and 2, the panel 10 is depicted in a progressive final configuration in which the panel 10 is further folded or bent along the fold line 22 so that the inner panel periphery 84 substantially continuously abuts, or is in juxtaposition with, the outer panel periphery 88. Within the scope of the claimed invention, “continuously” means “at every point” or “in entirety.” Thus, substantially every point of the inner panel periphery 84 substantially abuts the outer panel periphery 88, or substantially the entire inner panel periphery 84 abuts the outer panel periphery 88.

It is possible, within the scope of the claimed invention, for only a portion of the inner panel periphery and only a portion of the outer panel periphery to abut one another. For example, if only one of the inner panel portion and the outer panel portion includes a window frame portion, then the outer panel periphery and the inner panel periphery would abut, or be in juxtaposition with, one another only along a portion of each of the lateral edges 115 of the door.

The hem flanges 92 are preferably bent around the inner panel periphery 84 to join the inner panel periphery 84 and the outer panel periphery 88. Those skilled in the art will recognize a variety of other joining techniques, such as adhesive bonding, welding, etc, that may be employed within the scope of the claimed invention to join the inner panel periphery 84 and the outer panel periphery 88.

The inner panel portion 14 and the outer panel portion 18 are separated by a crease 116 along the lower edge of the door assembly formed at the fold line 22. In the context of the present invention, a “crease” is a portion of material that has been subjected to plastic deformation from bending or folding. Within the scope of the claimed invention, the crease may be formed along any suitable edge of a door. For example, a unitary, one-piece panel may have an inner panel portion and an outer panel portion separated by a generally vertical fold line about which the panel may be folded or bent to at least partially form a vehicle door. A crease formed at the generally vertical fold line would form a lateral, i.e., forward or rearward, edge 115 of a vehicle door.

The inner panel window frame 68 is aligned with the outer panel window frame 30 such that the inner panel window opening 72 is aligned with the outer panel window opening 34 to form a door window opening. A glass window 120 is installed after hemming to avoid breakage. Those skilled in the art will recognize the weatherstrips (not shown) and other components that are employed to guide the movement of the glass window 120 and seal the window 120 when it is in a closed position.

The inner panel portion 14 and the outer panel portion 18 at least partially define a cavity 124 therebetween in which the latch (not shown), the window regulator 112, and the window 120 are at least partially located. Edge 38 and edge 76 are substantially parallel and spaced apart to form an open space therebetween through which the glass window 120 extends. The inner panel portion 14 preferably includes openings 128 through which door hardware can be accessed for servicing during the service life of the door assembly.

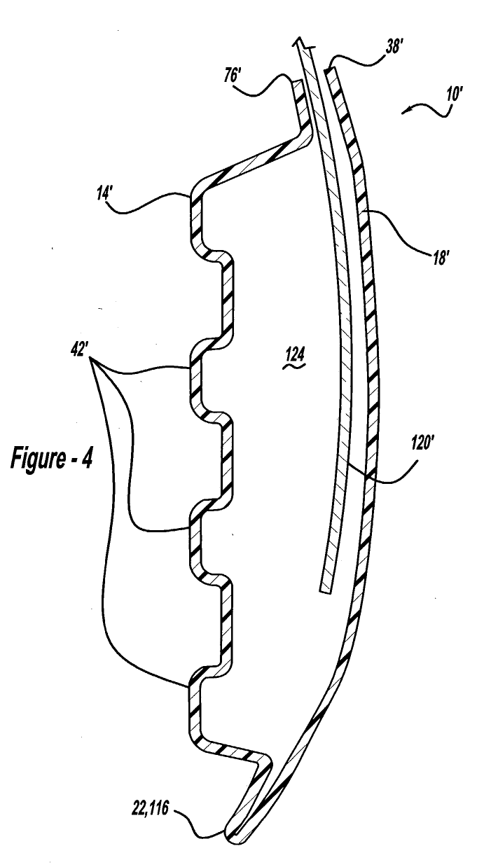

FIG. 4, wherein like reference numbers refer to like components from FIGS. 1-3, is a schematic cross-section of a door without a window frame having a panel 10′ forming an inner panel portion 14′ and an outer panel portion 18′. Edges 38′ and 76′ form a portion of the outer panel periphery and the inner panel periphery, respectively. Thus, along edges 38′ and 76′, the inner panel periphery is in juxtaposition with the outer panel periphery.

While the best modes for carrying out the invention have been described in detail, those familiar with the art to which this invention relates will recognize various alternative designs and embodiments for practicing the invention within the scope of the appended claims.

1. A vehicle door comprising:
a unitary, one-piece panel, the panel having an outer panel portion and an inner panel portion; wherein the panel is sufficiently bent between the inner panel portion and the outer panel portion such that the inner panel portion and the outer panel portion at least partially define a cavity therebetween.

2. The vehicle door of claim 1, wherein the inner panel portion is characterized by an inner panel periphery and the outer panel portion is characterized by an outer panel periphery, and wherein the inner panel periphery and the outer panel periphery substantially continuously abut one another.

3. The vehicle door of claim 2, wherein the inner panel portion of the panel and the outer panel portion of the panel are separated by a crease in the panel; wherein the inner panel portion extends from the crease to an inner panel sill partially defining a window opening; and wherein the outer panel portion extends from the crease to an outer panel sill further defining the window opening.

4. The vehicle door of claim 1, wherein the panel is formed by quick plastic forming.

5. The vehicle door of claim 1, wherein the panel is formed by superplastic forming.

6. The vehicle door of claim 1, wherein the panel is formed by sheet hydroforming.

7. The vehicle door of claim 1, further comprising a window regulator and a latch operatively connected to the inner panel portion.

8. A vehicle door comprising:
a unitary, one-piece panel, the panel characterized by a crease located between a first portion of the panel and a second portion of the panel; wherein the first portion is configured to partially define the exterior surface of a vehicle; and wherein the first portion and the second portion define a cavity therebetween.

9. The vehicle door of claim 8, wherein the door is characterized by lateral edges; wherein the panel is characterized by a periphery; wherein a first segment of the periphery is that part of the periphery on a first side of the crease and a second segment of the periphery is that part of the periphery on a second side of the crease, and wherein the first segment abuts or is in juxtaposition with the second segment along a portion of the lateral edges of the door.

10. The vehicle door of claim 8, wherein the second portion is characterized by stiffening corrugations and defines a plurality of apertures for the mounting of door hardware.

11. The vehicle door of claim 10, further comprising door hardware operatively connected to the second portion at the plurality of apertures and at least partially located within the cavity.

12. The vehicle door of claim 8, wherein the first portion and the second portion at least partially define a window opening.

13. The vehicle door of claim 12, wherein the first portion and the second portion each include a window frame at least partially defining the window opening.

14. The vehicle door of claim 8, wherein the panel is formed by quick plastic forming.

15. The vehicle door of claim 8, wherein the panel is formed by superplastic forming.

16. The vehicle door of claim 8, wherein the panel is formed by sheet hydroforming.

17. The vehicle door of claim 8, wherein the panel is comprised of a plastic material.

18. A method of assembling a vehicle door, the method comprising:
providing a unitary, one-piece panel, the panel having a first portion formed as a vehicle door outer panel and a second portion formed as a vehicle door inner panel.

19. The method of claim 18, further comprising bending the panel to form a crease between the first portion and the second portion.

20. The method of claim 19, wherein the panel is characterized by a periphery, and wherein a first segment of the periphery is that part of the periphery on a first side of the crease and a second segment of the periphery is that part of the periphery on a second side of the crease; and wherein said bending the panel includes bending the panel sufficiently such that at least a portion of the first segment substantially continuously abuts at least a portion of the second segment.

21. The method of claim 20, further comprising joining the first portion to the second portion along at least part of the first segment and the second segment.

22. The method of claim 21, wherein the first portion and the second portion define a cavity therebetween after said bending the panel; wherein the second portion defines a plurality of apertures for the mounting of door hardware; and wherein the method further comprises mounting door hardware with respect to the second portion at the plurality of apertures such that the door hardware is at least partially located within the cavity.

23. The method of claim 22, wherein the step of mounting door hardware is performed prior to the step of joining the first portion to the second portion.

24. The method of claim 21, wherein the method further comprises forming a sheet to produce the panel; wherein said forming the sheet includes placing the sheet in its substantially unformed, flat state between first and second die members movable between a die open position, for insertion of said sheet in its flat state and removal of the formed panel, and a die closed position in which said dies sealingly engage the periphery of said sheet for stretch forming of the die enclosed area of the sheet utilizing differential gas pressure, said first die member having a forming surface and defining a cavity between said forming surface and a first surface of said sheet, said second die having a sheet metal shaping surface opposite said cavity, said dies being in said die open position and said sheet being positioned between said preform surface and said cavity;
heating said sheet to a stretch forming temperature;
moving said dies to their closed position such that said first die engages the periphery of said sheet and pulls the heated sheet against said second die shaping surface to draw sheet material into said cavity so that said sheet is no longer flat and more sheet material is disposed within its sealingly engaged periphery than if the sheet had remained flat; and
applying gas pressure to the second side of said sheet to stretch the sheet into conformity with said first die forming surface.

25. The method of claim 24, wherein said sheet is comprised of an aluminum alloy.

26. The method of claim 24, wherein said sheet is superplastic formable and is heated to a superplastic-forming temperature before or during die closure.

27. The method of claim 24, wherein said sheet is a superplastic-formable Aluminum Alloy 5083 that is heated to a superplastic-forming temperature above 400° C. before or during die closure.

28. The method of claim 21, wherein the method further comprises forming a sheet to produce the panel, wherein the sheet is comprised of a magnesium-containing, aluminum alloy, said alloy comprising up to about 6% by weight magnesium and having a microstructure characterized by a grain size in the range of about 5 to 30 micrometers, and wherein said forming the sheet includes heating said sheet to a temperature in the range of about 400° C. to about 510° C.; and
stretching at least a portion of the heated sheet so that one side of the sheet is brought into conformance with a shaping surface by applying working gas pressure to the opposite side of the sheet, said stretching being accomplished by continually increasing said pressure from ambient pressure to a final stretching pressure in the range of about 250 psi to about 500 psi above ambient pressure and completing said stretching within a period of up to about 12 minutes.

29. The method of claim 28, further comprising increasing the rate of increase of said pressure at a time after about one minute of application of said pressure to a final stretching pressure in said range of about 250 psi to about 500 psi.

30. The method of claim 28, further comprising increasing said pressure to a level of 10 psi to 50 psi during the first minute of the application of said pressure and, thereafter, increasing said pressure at a rate faster than a linear rate of increase to a final stretching pressure in the range of about 250 psi to about 500 psi.

31. A vehicle door comprising:
a unitary, one-piece panel, the panel characterized by a crease located between a first portion of the panel and a second portion of the panel; wherein the first portion is configured to partially define the exterior surface of a vehicle; wherein the first portion and the second portion define a cavity therebetween;
wherein the door is characterized by lateral edges; wherein the panel is characterized by a periphery, and a first segment of the periphery is that part of the periphery on a first side of the crease and a second segment of the periphery is that part of the periphery on a second side of the crease, and the first segment abuts or is in juxtaposition with the second segment along at least a portion of the lateral edges of the door; and
wherein the first portion and the second portion at least partially define a window opening.
